(19) United States
(12) Patent Application Publication
(10) Pub. No.: US 2004/0037605 A1
(43) Pub. Date: Feb. 26, 2004

(54) Keypads for computers and typewriters

(76) Inventor: Mak Hing Kwok, Ryde (AU)

Correspondence Address: Thomas M Galgano, Galgano & Burke, Suite 135, 300 Rabro Drive, Hauppauge, NY, 11788, US

(21) Appl. No.: 10/276,078

(22) PCT Filed: May 14, 2001
(86) PCT No.: PCT/AU01/00549

(30) Foreign Application Priority Data
May 15, 2000 (AU) 35322/00

(51) Int. Cl. B41J 5/08

(52) U.S. Cl. 400/472

(57) ABSTRACT

A keystroke entry device for computer and typewriters is disclosed. The device is a 5 set of two keypads (35, 37) one for each hand, with casings (36, 38) for holding blocks of keys (1, 2 and 3). When not used in keypads, the key blocks are placed in a keyboard base (4) to become functioning parts of a keyboard. Each key block has a coiled extensible cord (5) connected to lire computer thus enabling keystroke entry at a distance. Each key block also has its own infrared beam projector system (17, 18) 10 that enables freestanding remote operation. The alphabet keys are organized, into six sequential strings headed by the vowels A, E, E, O, U, and Y (FIG. 4). This vowel based arrangement makes it easy to master the position or individual alphabet keys. Three consecutive strings are placed in one key block, and the other three in another key block (FIG. 4: 1, 2). Punctuation keys and essential typewriting function, keys are placed in unoccupied key sites in these key blocks. Single-handed typewriting is possible when these two key blocks are put together inside casings of a single keypad. They may nevertheless be put side by side for bi manual typewriting. With tile numeral keys and calculating operation keys specifically organized in a third key block (FIG. 4: 3), this device allows single handed calculating operations. With duplicate calculating operation keys placed in another key block (FIG. 4: 2), bimanual calculating operation is possible. Alternatively key blocks may be fixed to the two keypads without using casings, the keys being variously organized to suit (46, 47 and 48). As an option keys other than the ordinary ones may be organized as removable key blocks placed inside the keyboard base to be selectively included into the keypads (FIG. 6). Other variations of the device are also disclosed, including: alternative structuring of the keypad (FIG. 5) and adaptation to accommodate conventional layout of keys 35 into three blocks.

### BACKGROUND

This invention relates to improvements in devices for typewriting and keystroke entry for computers and typewriters.

### PRIOR ART

The conventional keyboard, of typewriters and computers (the two may hereafter be referred to as computers) must rest on some surface and cannot be hand held. And, because of the manner that the keys are laid out in the conventional keyboard, conventional typewriting requires the use of both hands as well as substantial training.

### INVENTION

These problems are overcome by the present invention, which provides a keystroke entry device comprising a set of two keypads, one for each hand, equipped with encasement device for holding removable blocks of keys which are organized to enable typewriting and computing with either one or both hands. Keypads can be hand held. Each key block is connected to the computer by extensible cords so that keystroke entry can be performed at a distance. Each key block also has an infrared beam projector with its own battery for electricity supply thus enabling freestanding remote operation. The alphabet keys in particular are organized in a vowel-based, layout that can be easily mastered. Complemented by appropriately organized punctuation keys and typewriting function keys all placed together into one keypad, one-handed typewriting is possible

According to one embodiment, of the invention, the keys are organized into three blocks of the same size so that any one of them can be fitted into any of the key block holders or casings in tile keypads. One keypad simply has a casing for holding a single block. The other has two casings arranged front to rear and hence can hold two key blocks. Each key block consists of four rows with six keys in a row. The vowel-based alphabet keys and the punctuation, keys plus essential typewriting function keys are placed into two key blocks. It can be seen that all the keys necessary for typewriting become available in one same keypad when the captioned two key blocks are placed inside its double casings, thus enabling one-handed typewriting with the captioned keypad. When not used in keypads the key blocks, including the third key block that holds the numeral keys and other computer function keys, are placed in a row in a, keyboard base so that they can be used as a, keyboard. The shapes and sixes if the keys, the key blocks and, the keypads may be varied to suit individual needs and, tastes.

In another form of the invention, a fourth key block is included to accommodate keys for robotics and sophisticated computer functions. The two keypads both have double casings, and any one or two of the key blocks can be put into either keypad. In an alternative embodiment of the invention, the keys are organized into two blocks fixed inside two keypads. Each, block consists of six rows, with six keys in a row. The keypads (together with the blocks of keys) can lie put alongside each other inside the keyboard base so that they can be used as a keyboard.

In another form of the invention, a conventional layout of keys is adapted such that the left hand keys, the right hand keys, and the remaining keys (including numerals) are fitted into three key blocks arranged from, left to right in the keyboard base.

### DETAILED DESCRIPTION

To assist with understanding the invention, reference will now be made to the accompanying drawings that show examples of the invention.

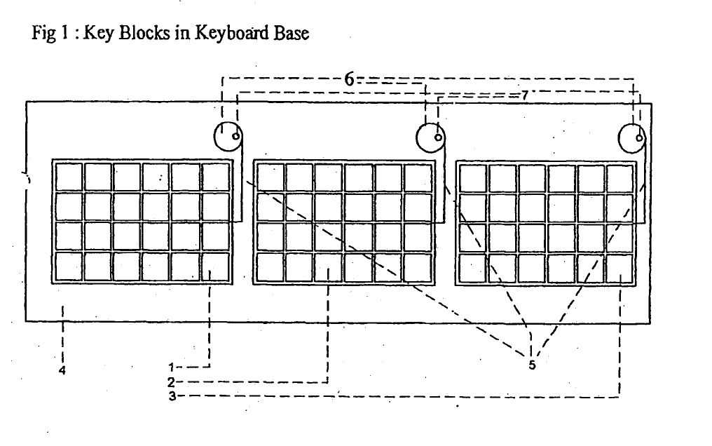

FIG. 1 shows three blocks of keys 1, 2 and 3 placed inside depressions in the keyboard base 4. There are grooves in 1:110 keyboard base together with retaining mechanisms to accommodate coiled extensible cords 5 for the blocks. Automatic retrieval mechanism is additionally provided in spools 6. There are also provisions for manual winding 7. The keyboard base also holds power switches and other accessories as necessary.

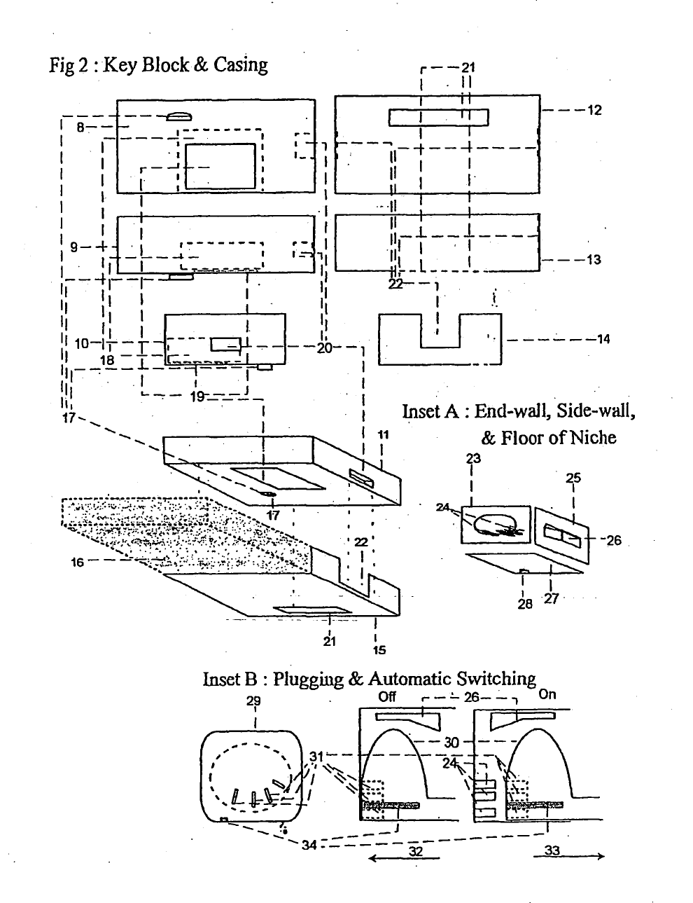

FIG. 2 shows the bottom view 8, rear end view 9, right side view 10, and the three dimensional view 11 of a key block in relation to corresponding views of the casing 12, 13, 14 and 15. In the three-dimensional view the casing is shown attached to the handle 16 of the keypad. The key block has an infrared beam protector 17 jutting down near the front at the bottom. The projectors for the several key blocks are severally placed at the center, right-of center and left of centre respectively. Each block has a battery compartment 18 each with a lid 19 opening at the bottom. In the middle of the right side of the block there is a niche 20 for accommodating the ping and socket mechanism for the extensible cord 5, The casing has a slot 21 at the underside in the front portion to allow any projector 17 to protrude through. On the sides in the middle of the casing there are notches 22 to allow passage of the plug for the extensible cord and to facilitate handling of the block inside the casing. All casings have simple mechanisms for gripping the key block securely, e.g., curled metal strips.

Inset A of FIG. 2 shows the end-wall 23 of the niche 20 with pins 24 for plugging in the extensible cord 5. On the side-wall 25 there is a centrally pivoted switch 26 for connecting electricity supply from the battery to the key block On the floor 27 of the niche, there is a knob 28 placed variously for the several key blocks to serve as a guide 30 for the appropriate plug,

Inset B of FIG. 2 show the end view 29 and topside view 30 of the plug. There are receptacles 31 for the pins 24. One side of the plug is dome shaped—With plugging in the plug glides inward into the niche 20 and presses down the inner part of the switch 26 at the final stage to obtain the off position. When the plug is pulled out, the outer part of the switch is pressed down to the on position by the outward motion, of the dome. There is also a trough 34 on the underside of the plug to accommodate the knob 28 and to guide the movement of the plug The knobs and troughs for the several blocks and plugs are severally placed so that only the appropriate plug can pass through into the niche of the appropriate block

It can be seen that with the extensible cord for the key block, keystroke entry can be performed at a distance from the keyboard and computer whereas truly cordless, remote computing is possible with the use of infrared beams. Extensible cords are preferred in the office setting with multiple computers since mistaken pointing of the infrared beam may cause problems. Radio waves may be used instead of infrared beams and will not require projectors, but unless the blue tooth technology can be applied, problems arise when there are multiple computers in the room or within range.

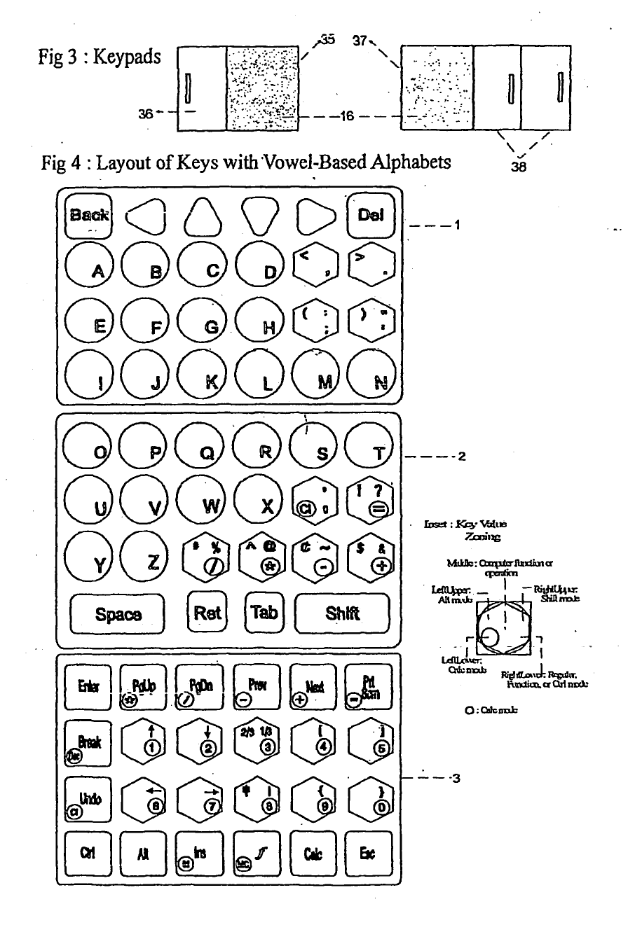

FIG. 3 shows the keypads. Each keypad has a handle 16. The simple keypad 35 has a single casing 36 fixed to the handle. The other is a composite keypad 37, having double casing 38 arranged front to rear.

FIG. 4 shows the layout of the keys, all of which are organized for optimal user friendliness, i.e., maximal convenience and ease to memorize.

The alphabet keys are arranged in six strings headed by the vowels A, E, I, O, U and Y. With this vowel-based layout, the positions of individual alphabet keys can, lie easily mastered. The first three strings are placed at the rear of key block 1. The other three strings are placed at the front of key block 2. Punctuation keys are placed in the unoccupied sites after the alphabets. Cursor movement keys and essential typewriting function keys are placed in a row at the front of key block 1. Other essential typewriting function keys are placed in a row at the rear of key block 2.

When key blocks 1, and 2 are placed together in the double casing 38 of the composite keypad 37, all alphabet as well as punctuation keys and essential typewriting function keys are available in the one same keypad 37 so that one-handed typewriting is possible. With other combinations, typewriting is performed with both hands.

Number keys are arranged in two equal rows placed at the right side in the middle of key block 3. When the calculating mode is toggled on, numbers become numerals. Computer function keys are placed in a row in front of and another row to the rear of the number keys. More function keys are placed in a column to the left of them all. Calculating operators are placed, as necessary in appropriate computer function key sites in key block 3 to replace computer functions when the calculating, mode is Toggled on. With this arrangements key block 3 can be use single-handedly as a calculator, Essential calculating operator keys that are activated: in calculating mode are also placed in appropriate punctuation key sites of key block 2. With key block 2 and key block 3 placed separately, bimanual calculating operation is possible if the) user prefers using both hands because it could be less tiring and faster than using one hand only.

To facilitate recognition in the figure, alphabet keys are shown, as round-shaped punctuation and number keys are hexagon shaped, function/operator keys are shaped as squares or rectangles with rounded angles, and cursor movement keys are shaped as rounded triangles.

It is worth, noting that as an alternative key blocks 1 and 2 may be fixed in one keypad, while the other keypad has key block 3 fixed to it This allows single-handed typewriting but flexibility is lost as compared to having removable key blocks.

The inset in FIG. 4 shows the schematic representation of key values in various modes.

The middle of the key represents a computer function or typewriting operation, which, as a rule is superseded only by the calculating mode where specifically represented on the key.

The right lower corner represents key value in regular mode, the function name (including any user defined function) when in function mode, the macro function name when in control mode, and, where specifically indicated by the circle sign, the key value in calculating mode also. Key values in control mode are best reserved for calling up software programs or subprograms and are not shown on the key's so as to avoid cluttering but are shown in a menu on screen when required. In particular, cursor movement keys will become mouse movement keys when in control mode.

The left tower corner is reserved for the calculating mode.

The right upper corner represents the key value in shift mode. For alphabet keys, the shift mode toggles on the capitals just as with the conventional keyboard. The left upper corner represents the key value in alt mode. For alphabet keys, the alt mode toggles on corresponding alphabets in another language as is applicable, e.g., Greek. Where not represented on the key, an on-screen dialogue box is used when in alt mode for assisting the user to add on or call up icons or macros.

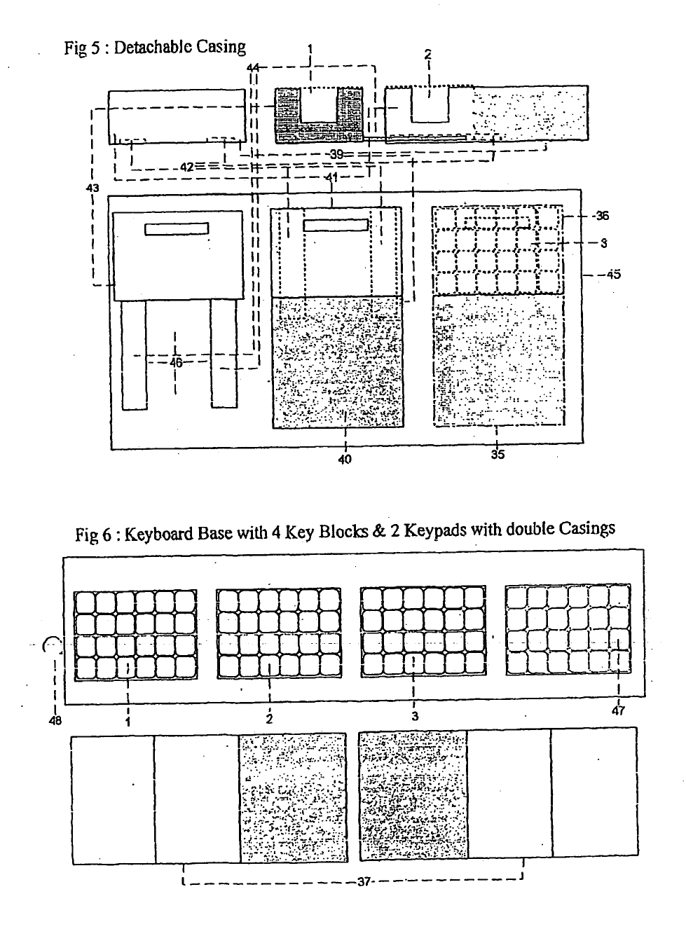

FIG. 5 shows an alternative for the composite keypad. This form of the composite keypad has two parts. The first part 39 has a handle 40 and a fixed single casing 41.

There are two sheaths 42 in the underside near the side stretching over the whole length of the casing 41, from the front and extending into the front part of the handle 40. The other part is a detachable casing 43 with two slats 44 at the; bottom jutting out backwards from the rear end. The slats can be inserted into the sheaths 42 to join the two parts together. Note that joining of the two parts may be effected and/or reinforced by other mechanisms such as hooks, clips or snapping buckles. Also the detachment may instead be placed between the keypad and the casing. Key block 1 is placed in the detachable casing 43. Key block 2 is placed in the casing 41 of the first part of the composite casing 39. Key block 3 is placed in the casing 36 of the simple keypad 35. The three key blocks together with casings and all are sequentially put in a row inside depressions in the keyboard base 45. The unoccupied space 46 to the rear of the detachable casing 43 can be used to accommodate a notepad or a mini scanner. This arrangement is more compact in that all key blocks and keypads (parts and whole) are neatly accommodated inside the keyboard base 45.

FIG. 6 shows an extended form of the invention, there is an additional, fourth, key block 47 with keys assigned for robotics and specialized computer functions. Any one or two of the key blocks can be placed inside any of the casings of any of the two composite keypads 37 They can all be neatly accommodated in the keyboard base 48.

It will be realized that, with the use of casings for removable key blocks, there is option to have any number of extra blocks of keys put into the keyboard base for selective inclusion into the key pads.

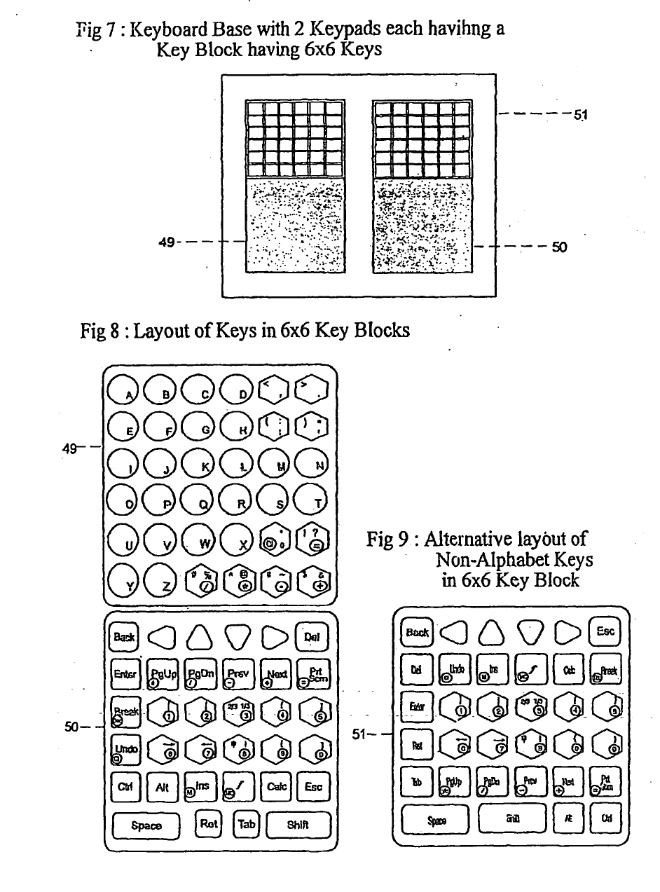

FIG. 7 shows a simplified form of the invention. The keys are organized into two equal sized key blocks 49 and 50, each with six row's of keys having six keys in a row. Since there is no combinatorial alternative, casings are not used and the key blocks arc fixed on the keypads. When placed alongside each other inside keyboard base 51, they can be used as a keyboard.

FIG. 8 shows the arrangement of keys in this example of the simplified form of the invention. The key block 49 and 50 consists of alphabet and punctuation keys as described in key blocks 1 and, 2 but without the function keys. The keys as described in key block 3 are placed in the middle rows of the other key block 50, with function/operation keys as described in key block 1 placed at the front and those in key block 2 placed at the rear. This simplified form of the invention is much more compact But when, used, as keypads, single-handed typewriting is not fully supported—although, the user can perform alphabet and punctuation entry with one hand alone and may even be able to do typewriting with one hand when used as a keyboard.

FIG. 9 shows an alternative arrangement of keys for key block 50. In this alternative key block 51, the numerals are placed at the right of the block in the middle two rows Oust the same as in FIG. 8). However, typewriting function/operation keys are placed in the left most column of the block as well as in the foremost row and in the rear most row, while other function keys are placed in the second rows both at the front and in the rear. With this alternative, the essential typewriting function keys are more close to the alphabet-punctuation key block 49 so that it is easier for one-handed typewriting when used as a keyboard.

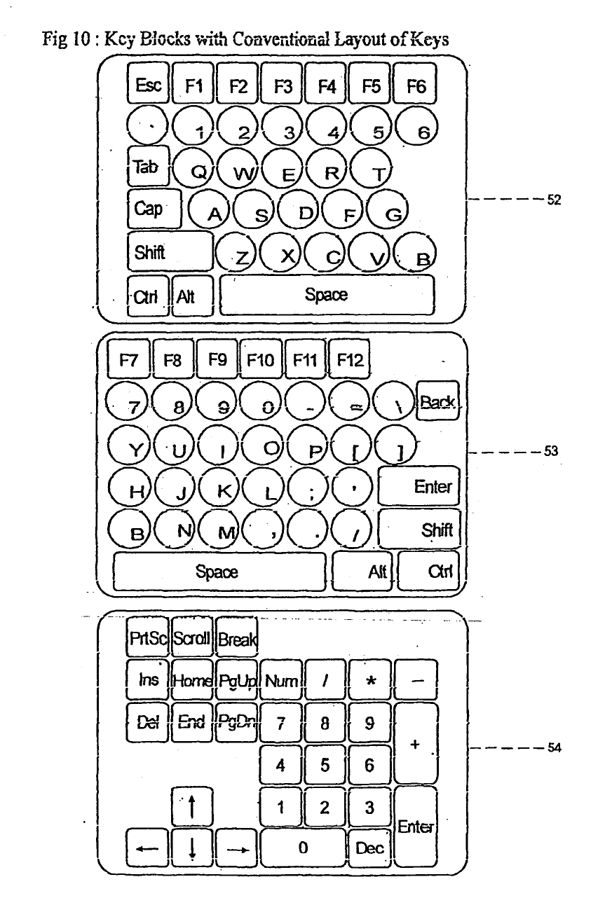

FIG. 10 shows another form of the invention with the conventional layout of keys fitted inside three key blocks 52, 53 and 54. Left hand keys, right hand keys, and the remaining keys are packed into the key blocks respectively. The key blocks, are placed sequentially in a keyboard base to Junction like a conventional keyboard. When 25 placed, inside casings in keypads, remote computing and distant typewriting is possible. But single-handed typewriting is not supported. It will be recognized by persons skilled in the art that numerous variations and modifications may be made to the invention as broadly described herein without departing from the overall spirit and scope of the invention.

The claims defining the invention are as follows:

1. A keystroke entry device comprising a set of two keypads, one for each hand, the keypads equipped with an encasement device for holding removable blocks of keys which are organized to enable typewriting with either one or both hands.

2. The keystroke entry device of claim 1 wherein the blocks of keys are optionally placed into a keyboard base to perform the function of a keyboard.

3. The keystroke entry device of claim 1 wherein the keys are organized into three key blocks each having four rows with six keys to a row, two of the key blocks mainly for typewriter function and the third for calculator function.

4. A keystroke entry device wherein, the alphabet keys are arranged in, a vowel based layout having—six strings of sequential alphabets headed, by the vowels A. E, I, O, U, and Y, wherein said vowel-based layout facilitates mastery of the positions of individual alphabet keys.

5 The keystroke entry device of claim 4 wherein three strings each of the alphabet keys plus complementary punctuation and essential typewriting keys are placed inside two key blocks, thereby enabling one-handed typewriting with a keypad when the two captioned key blocks are put in the casings.

6. The keystroke entry device of claim 3 wherein numeral keys, arranged in two equal rows, are placed in said third key block together with calculating operation keys to enable single-handed calculator function with one keypad.

7. The keystroke entry device of claim 6 wherein duplicate calculating operation keys are placed in another key block to enable bimanual calculating.

8. A keystroke entry device wherein the blocks of keys are furnished not only with extensible cords that enable distant typewriting and computing, but also with infrared beam projectors to enable freestanding remote typewriting and computing,

9 The keystroke entry device of claim, 8 wherein a switching device automatically switches a battery for the key block off or on when the extensible cord is plugged in or pulled out.

10 The keystroke entry device of claim 1 wherein the encasement device of the keypad is detachable and is rejoined with slats sliding into sheaths.

11. The keystroke entry device of any of claims 1 and 2 wherein function keys for specialised and technologically advanced computer function keys are included, as one or more key blocks in addition to key blocks containing ordinary keys.

12. A variation of the keystroke entry device of claim 1 wherein the key blocks, instead of being removable, are fixed to the two keypads.

13. The keystroke entry device of any of claims 4, 5 and 12, wherein one keypad holds all the vowel-based stings of alphabet keys plus punctuation keys while the other keypad holds all the other keys.

14. The keystroke entry device of any of claims 1 and 2 wherein the conventional left hand keys, right hand keys, and the remaining keys, including numeral keys, are packed into three key blocks in a manner similar to the conventional layout of 45 keys.

15. The keystroke entry device substantially as herein described with reference to the accompanying drawings.
